(19) United States
(12) Patent Application Publication
(10) Pub. No.: US 2015/0260343 A1
(43) Pub. Date: Sep. 17, 2015

(54) PROTECTIVE CAP FOR GAS CYLINDER WITH ELECTRONIC DISPLAY SCREEN POSITIONED TOWARDS THE TOP

(71) Applicant: L'Air Liquide, Société Anonyme pour l'Etude et l'Exploitation des Procédés Georges Claude, Paris (FR)

(72) Inventors: Emmanuel BAUNE, Saint Prix (FR); Damien GERMANI, Paris (FR); Renaud LIGONESCHE, Herblay (FR); Philippe RUDNIANYN, Villiers sur Orge (FR); Chiara TARANTELLO, Puteaux (FR)

(21) Appl. No.: 14/642,278

(22) Filed: Mar. 9, 2015

(30) Foreign Application Priority Data
Mar. 12, 2014 (FR) 1452036

(51) Int. Cl. F17C 13/00; F17C 13/06; F17C 13/04

(52) U.S. Cl. CPC F17C 13/003; F17C 13/04; F17C 13/06; F17C 2203/014; F17C 2205/0308; F17C 2205/0323; F17C 2205/05; F17C 2270/02

(57) ABSTRACT

The invention relates to a gas distribution assembly comprising a gas cylinder (2), a valve-assembly fixed to the gas cylinder (2) and a protective cap (1) arranged around the said valve-assembly. The protective cap (1) comprises a housing (4) formed at the upper part (1a) of the protective cap (1) and in which housing (4) an electronic display screen (3) is housed. A carry handle (6) surmounting the cap (1) is connected to the cap (1) by one or more support uprights (5), to allow the gas distribution assembly according to the invention to be transported. For preference, an attachment device (10) allows the assembly to be secured or hooked onto a support of tubular shape, particularly a bar of a hospital bed or of a stretcher.

### CROSS REFERENCE TO RELATED APPLICATIONS

This application claims the benefit of priority under 35 U.S.C. §119 (a) and (b) to French Patent Application No. 1452036 filed Mar. 12, 2014, the entire contents of which are incorporated herein by reference.

### BACKGROUND

The invention relates to an assembly for distributing gas, notably medical gases, comprising a gas cylinder, a valve-assembly fixed to the gas cylinder and a protective cap arranged around the said valve-assembly, and comprising an electronic display screen allowing the display of information, which is then housed in the upper part of the said protective cap.

Industrial and medical gases are commonly packaged into gas containers, typically gas cylinders, equipped with a valve-assembly, with or without inbuilt pressure regulator, namely a simple valve of the open/closed type or a valve with an inbuilt regulator, also referred to as a regulating valve, that allows control over the flow rate and pressure of the gas delivered.

In order to protect this valve-assembly, it is common practice to arrange at the neck of the gas cylinder, and around the said valve-assembly, a protective cap that forms a protective shell around the said valve-assembly. Such a cap is commonly referred to as a “bonnet”.

Moreover, in order to allow the cylinder/bonnet/valve-assembly to be attached to a support, such as a bar of a hospital bed, a stretcher, a rung or attachment support of an emergency vehicle, for example an emergency ambulance service vehicle or the like, it is commonplace for a fixed or mobile, notably pivoting, attachment system to be formed on the bonnet.

To make transporting and handling the cylinder/valve-assembly/cap assembly easier it is commonplace for the cap to be provided with a carry handle which, in general, surmounts it and allows users to carry it by hand using one hand.

Caps of this type are notably described by documents EP-A-629812, DE-A-10057469, US-A-2004/020793 and EP-A-2586481.

It is known practice for the user to be supplied with information relating to the gas delivered by the cylinder (type of gas, pressure, autonomy, etc.).

To do that, use may be made of a gas pressure indicating device such as a pressure gauge, or a gas autonomy indicating device which is fixed to the valve-assembly or to the regulating valve.

Now, positioning this device at the bottom of the valve, because of technical constraints, notably because of the fact that the protective cap surrounds the valve-assembly or regulating valve, means that it is often difficult or awkward to read the information given by the device, this inevitably leading to reading errors which may lead to breaks in the supply of gas because a user who has mis-read may fail to notice that the gas cylinder is empty or almost empty.

In addition, while supplying the user with information relating to the gas delivered by the cylinder (type of gas, pressure, autonomy) is important, this information is not enough and users increasingly need to have further useful information (date, time, place, name of the hospital, etc.).

Now, there is not currently in existence any gas distribution assembly equipped with a device that is able to supply a user with a wide range of information.

Elsewhere, document EP-A-2339222 teaches a gas cylinder equipped with a protective shell arranged around only the cylinder body, which shell is fitted with carry handles. A screen is formed in the lateral body of the shell and allows the temperature of the gas in the container to be monitored. However, the valve-assembly is not protected by any cap, and this leads to risks of this valve-assembly becoming damaged, in the event of a knock or a fall, and what is more having the screen arranged laterally on the shell greatly limits the ease with which the information displayed can be read.

Furthermore, document U.S. Pat. No. 5,440,477 proposes a gas cylinder equipped with a gas management system formed of an electronic unit with a screen that is mounted around the valve-assembly. This management system allows the outlets of gas to be managed, but does not seek to protect the valve against falls. Furthermore, a cylinder thus equipped is not intended to be transported but rather to be positioned permanently in a cabinet for the distribution of gas or gaseous mixtures. Likewise, it is used solely in a vertical position.

In view of the above, the problem that presents itself is that of providing a gas distribution assembly that allows the user to be supplied not only with information relating to the gas delivered by the cylinder (type of gas, pressure, autonomy) but also, and if desired, with other useful information (date, time, place, name of the hospital, etc.), and for this information to be made readily accessible, i.e. readable by the user, therefore avoiding all or some of the aforementioned problems. In addition, the cylinder needs to be able to be transported easily from one place to another and used equally well in the vertical and horizontal positions, with this information remaining visible and legible whatever the position of use adopted. Finally, protection of the gas distribution valve-assembly against knocks and falls must also be provided.

### SUMMARY

The solution of the invention is a gas distribution assembly comprising a gas cylinder, a valve-assembly fixed to the gas cylinder and a protective cap arranged around the said valve-assembly, characterized in that the protective cap comprises:
a cap body forming a protective shell around an internal volume sized to accommodate the valve-assembly,
a housing formed at the upper part of the protective cap and in which housing an electronic display screen allowing the display of information is housed, and
a carry handle surmounting the cap and connected to the cap by one or more support uprights.

An “electronic display screen” means a screen able and designed to display any type of information “alphanumerically” and/or graphically, namely in the form of one or more alphabetic and/or numerical characters, of pictograms, of drawings or the like.

Depending on circumstance, the assembly of the invention may comprise one or more of the following technical features:
the electronic display screen is a liquid crystal display (LCD) screen.
the electronic display screen is of OLED (Organic Light-Emitting Diode) type.
the electronic display screen is a laser screen.
the electronic display screen is a screen of the type using electronic ink.
it further comprises one or more sensors, notably a gas pressure or gas flow rate sensor, a sensor sensing the position of the gas releasing member (handwheel, lever, etc.), a temperature sensor, a sensor sensing the presence of the user, an accelerometer or any other sensor.
it further comprises data processing means transmitting information to the electronic display screen, the said electronic display screen displaying at least some of the said information transmitted by the data processing means.
the data processing means comprise a microprocessor and a data storage memory.
it further comprises at least one electric power source supplying at least the screen with electrical current, preferably one or more electric batteries, cells or photovoltaic panels, for example a rechargeable battery associated with a non-rechargeable cell, or a battery associated with a photovoltaic panel, or some other combination.
the protective cap comprises a plane surface at its upper part, the housing in which the screen is housed being formed in the said plane surface.
the plane surface forms a face that is oblique with respect to the axis AA of the cap (or the axis of the cylinder), the axis BB of the screen and the axis AA of the cap forming between them an angle α less than 70°, preferably less than 60°.
the cap comprises at least one internal housing in which the data processing means and the electric power source are arranged.
the valve-assembly is a valve with an inbuilt regulator.
the cap is made of polymer, preferably of plastic.
the protective cap comprises a carry handle connected to the cap by several support uprights.
the carry handle is arranged on the cap in such a way that the electronic display screen is positioned between the carry handle and the valve-assembly.
the electronic display screen displays at least one item of information chosen from the time, the date, the flow rate of gas delivered by the valve, the gas pressure inside the cylinder, the autonomy of the cylinder, the autonomy of the electric power source, the ambient temperature, the name of the care establishment, the nature of the gas, the expiry date of the gas or an alarm (e.g. temperature, need for maintenance, remaining time of use, for example under 15 min, under 5 min, etc.).
the protective cap further comprises an attachment device, preferably a pivoting attachment device.
the protective cap comprises an opening formed laterally in the protective cap and within which is housed a control member for example a rotary handwheel, a linear slider or a pivoting lever, preferably a rotary handwheel, for controlling the gas flow rate.
a gas outlet connector allowing the gas delivered by the valve-assembly to be withdrawn is arranged in or projects in an opening formed laterally in the protective cap.
the control member controlling the gas flow rate is a rotary handwheel and is arranged coaxial with and able to rotate about the gas outlet connector within the opening formed laterally in the protective cap.
the electronic display screen is arranged in the housing formed in the plane surface so that it lies flush with the said plane surface.
alternatively, the electronic display screen is arranged in the housing formed in the plane surface so that it is set back in the said housing with respect to the said plane surface, preferably set back by 0.1 to 10 mm.
as a further alternative, the electronic display screen is arranged in the housing formed in the plane surface so that it protrudes from the housing with respect to the said plane surface, preferably so that it protrudes by 0.1 to 10 mm.
the electronic display screen has minimum dimensions of the order of 30×30 cm and maximum dimensions of the order of 100×100 cm, for example of the order of 55×50 cm.
the valve-assembly further comprises a gas outlet connector.
the valve-assembly further comprises a gas filling connector.
the electronic display screen is arranged on the front face of the cap.
the attachment device, preferably pivoting, is arranged on the rear face of the cap.
the attachment device comprises two parallel arms able to pivot with respect to the body of the cap and forming securing hooks, for preference, the two pivoting arms are connected to one another in such a way as to pivot simultaneously with one another.
the two parallel arms of the attachment device are configured and sized so as to allow the assembly to be secured or hooked onto a support of tubular shape, particularly a bar of a hospital bed or of a stretcher.
the cap is made of polymer or of metal or of metal alloy, preferably of plastic, such as PVC, PE, PET, PP, PMMA, PU, PA, etc. It should be noted that the plastic may be filled or reinforced, i.e. may have fibres for example added to it.
the carry handle and/or the support uprights are made of a rigid material chosen from polymers and metals or metal alloys.
the carry handle is longiform overall. Typically, its length is between 5 and 20 cm, preferably between 6 and 15 cm.
the carry handle surmounts the cap body, i.e. is situated so that it projects and/or protects at the top, above the cap.
the carry handle is horizontal or near-horizontal and is perpendicular to the axis of the cap.
the gas cylinder has a size of between 10 and 150 cm.
the gas cylinder contains 0.5 to 20 litres (water-equivalent capacity).
the gas cylinder has a hollow cylindrical body.
the gas cylinder comprises a neck bearing a gas outlet orifice to which the valve-assembly is fixed.
the gas cylinder contains a gas or gaseous mixture chosen from oxygen, air, an N₂O/O₂ mixture, a He/O₂ mixture, an NO/nitrogen mixture or any other gas or gaseous mixture.
the cylinder is made of steel, of an aluminium alloy, or of composite material or of a combination of several of these materials, preferably of an aluminium alloy.
the cylinder contains a gas at a pressure ranging up to around 350 bar.

The invention also relates to a use of a gas distribution assembly according to the invention to distribute a gas or gaseous mixture, preferably a medical gas or gaseous mixture. For preference, the gas or gaseous mixture is chosen from oxygen, air, N₂O/O₂, He/O₂, NO/nitrogen.

### BRIEF DESCRIPTION OF THE DRAWINGS

The invention will now be better understood by virtue of the following detailed description, given by way of nonlimiting illustration, with reference to the attached figures among which:

FIG. 1 depicts a first embodiment of the protective cap of a cylinder/valve-assembly/cap assembly according to the invention, and

FIG. 2 depicts a second embodiment of the protective cap of a cylinder/valve-assembly/cap assembly according to the invention.

### DESCRIPTION OF PREFERRED EMBODIMENTS

The figures depict two embodiments of a protective cap 1, commonly referred to as a “bonnet”, arranged around a valve-assembly (not visible), namely a valve with or without an inbuilt regulator, itself fixed to the neck of a gas cylinder 2, preferably the valve-assembly is of the regulating valve type.

The fixing onto the neck of the gas cylinder 2 around the valve-assembly is performed by screwing.

The gas cylinder 2 typically has a cylindrical body made of steel and a size of between 10 and 150 cm, and a capacity of 0.5 to 20 litres (in water-equivalent).

The protective cap 1 protects the valve-assembly against knocks. To do that, it comprises a cap body forming a protective shell around an internal volume dimensioned to accommodate the valve-assembly.

As may be seen in the figures, it is surmounted by a carry handle 6 designed to be held by a user in one hand. The carry handle 6 is made of a rigid material such as a polymer or a metal or metal alloy and is supported by one or more support uprights 13 mechanically connecting the cap body to the carry handle 6. It is preferably arranged horizontally, i.e. perpendicular or near-perpendicular to the vertical axis of the cylinder 2 and of the cap 1. The carry handle 6 has a longilinear shape, whether rectilinear or curved, typically a length less than 20 cm, typically of 6 to 15 cm.

One or more support upright(s) 5 are fixed to one or both ends of the carry handle 6 so as to allow a user easily to transport the bonnet/valve/cylinder assembly using the said carry handle 6.

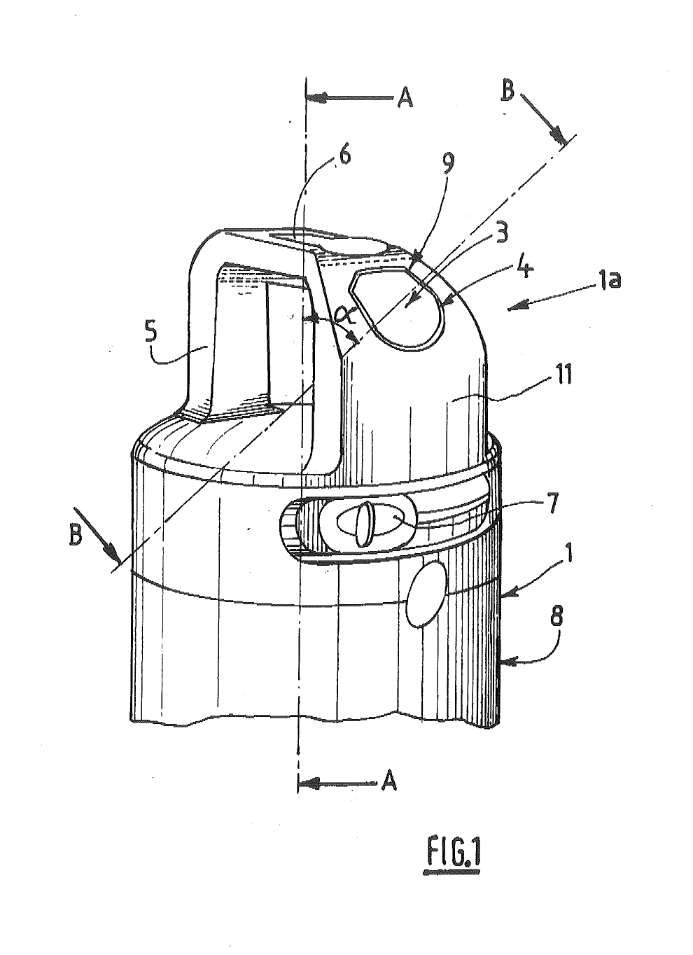

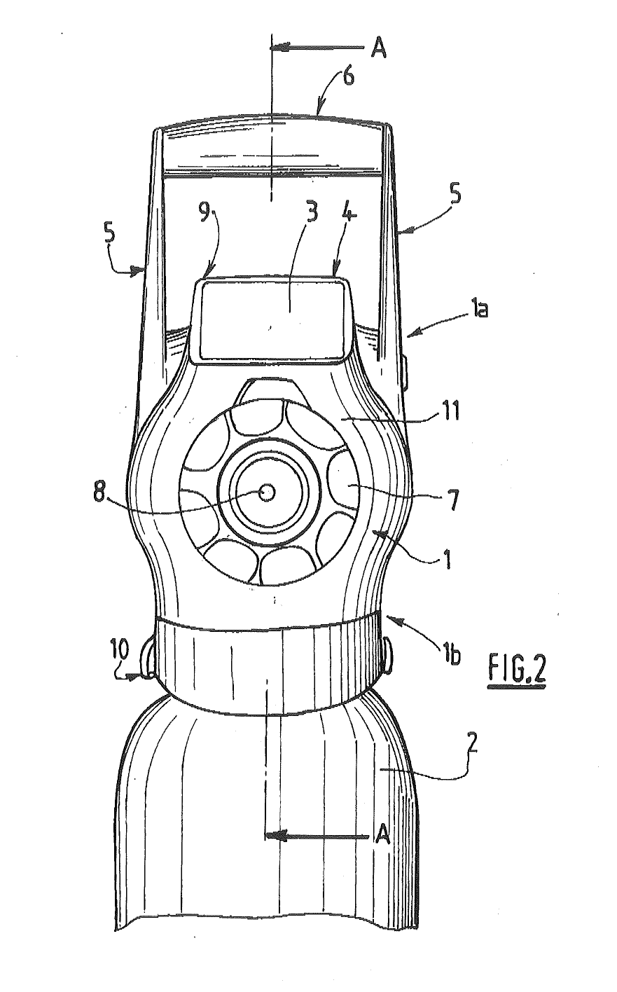

In the embodiment of FIG. 2, the handle 6 is supported by two support uprights 5 mechanically connecting the two ends of the said handle 6 to the cap body 1, whereas in the embodiment of FIG. 1, it is supported by a single support upright 5 mechanically connecting one of the ends of the handle 6 to the cap body 1, the other end of the handle 6 being connected directly to the cap body 1 the front face 11 of which is configured to extend, i.e. project, upwards.

In any event, the cap body 1 is typically made of a material of the polymer type and/or of metal, preferably of a plastics material such as PVC, PE, PET, PP, PMMA, PU, PA, etc. Likewise, the support uprights 5 may be formed of a plastics material like the cap body 1, but may also be formed of aluminium alloy or any other metallic material. They may be fixed to the handle 6 by screwing or welding for example, or formed as a single piece.

The protective cap 1 also has an opening or housing 4 formed at the upper part 1a, also referred to as the top part, of the front face 11 of the protective cap 1, in which housing 4 an electronic display screen 3 for displaying various pieces of information useful to the user is housed. The lower part 1b, also referred to as the bottom part, of the cap 1 is situated at the level of the cylinder 2.

The electronic display screen 3 is, for example, an LCD screen.

For example, the screen 3 is designed and able to display information chosen from the time, the date, the flow rate of gas delivered by the valve, the pressure of the gas in the cylinder 2, the gas autonomy of the cylinder 2, the autonomy of the electric power source, the ambient temperature, an alarm, the name of the care establishment or the like.

In order to be able to display all or some of this information, one or more sensors, such as pressure, flow rate, control member (lever or handwheel) position, user presence, or other sensors, are also provided.

The measurements taken by this or these sensors are processed by data processing means, for example a microprocessor associated with one or more algorithms, and are then potentially stored in a data storage memory and finally transmitted, via a suitable connection, to the electronic screen 3 on which they may be displayed.

An electric power source, for example one or more batteries or electric cells, supplies the screen 3 and the sensor or sensors, and the data processing means, particularly the microprocessor, and, where applicable, the data storage memory, with electrical current.

The data processing means and the electric power source are arranged in one (or more) internal housing(s) formed in the cap 1.

As illustrated in FIGS. 1 and 2, a plane surface 9 is formed at the front face 11 of the upper part 1a of the protective cap 1, in which plane surface 9 the housing 4 accommodating the electronic display screen 3 is formed.

In the embodiment of FIG. 1, the housing 4 is formed in the front face part 11 configured to extend, i.e. to project, upwards and acting as a support upright for the carry handle 6.

For preference, the axis BB of the screen 3 is oblique with respect to the axis AA of the cap 1 and of the cylinder 2, which means to say that the said axes AA and BB form between them an angle α less than 70°, preferably less than 60°, as indicated schematically in FIG. 1.

According to the embodiment considered, the screen 3 is arranged in the housing 4 formed in the plane surface 9 so that its upper window lies flush with the said plane surface 9, or is set back slightly within the housing 4 or, conversely, protrudes outwards slightly beyond the plane surface 9.

Arranging the screen 3 at the top 1a and on the facade 11 of the cap 1 in this way with its reading window inclined to make a given angle α (<70°) with respect to the axis AA of the cap 1 and of the cylinder 2 means that it becomes considerably easier for the user to read the information delivered by the electronic display screen 3 and avoid reading errors.

Moreover, the protective cap 1 comprises a control member such as a rotary handwheel 7 (FIG. 2) or a slider (FIG. 1) controlling the flow rate of the gas passing through the valve-assembly.

In the embodiment of FIG. 2, which is preferred, the rotary handwheel 7 is situated on the front face and arranged around a gas outlet connector 8 that allows the gas delivered by the valve to be withdrawn.

In order to allow the cylinder/valve-assembly/cap assembly to be attached or secured to a support, such as a bar of a hospital bed or of a stretcher, the protective cap 1 may, on the side of its rear face, comprise an attachment device 10 able to pivot between a fully folded “rest” position, namely the position adopted by the attachment device 10 when it is stored and in contact or near-contact with the body of the cap 1 (as illustrated in FIG. 2), and a fully unfolded “attachment” position, namely the position adopted by the attachment device 10 when completely deployed and can be hooked onto a support, such as a bar of a bed or the like.

The attachment device 10 comprises two parallel arms able to pivot with respect to the body of the cap, which arms form securing hooks. For preference, the two pivoting arms are connected to one another, for example via a connecting element, in such a way as to pivot simultaneously with one another.

The attachment device 10 is therefore configured and sized, particularly in so far as the two arms are concerned, to allow it to be secured or attached to a bar of a hospital bed or of a stretcher, namely to a support of tubular overall shape.

A gas cylinder 2 equipped with a cap 1 according to the invention is particularly well suited to use in a medical environment and is particularly suitable for storing any medical gas or gaseous mixture, particularly of the oxygen, air, N₂O/O₂, He/O₂, NO/nitrogen or other type.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A gas distribution assembly comprising a gas cylinder, a valve-assembly fixed to the gas cylinder and a protective cap arranged around the said valve-assembly, wherein the protective cap comprises:
a cap body forming a protective shell around an internal volume sized to accommodate the valve-assembly,
a housing formed at the upper part (1a) of the protective cap and in which housing an electronic display screen is housed, and
a carry handle surmounting the cap and connected to the cap by one or more support uprights.

2. The assembly of claim 1, wherein the valve-assembly further comprises one or more sensors.

3. The assembly of claim 1, wherein the valve-assembly further comprises a data processing system configured to transmit information to the electronic display screen, the electronic display screen adapted to be capable of displaying at least some of said information.

4. The assembly of claim 3, wherein the data processing system comprises a microprocessor and a data storage memory.

5. The assembly of claim 3, wherein the valve-assembly comprises an attachment device.

6. The assembly of claim 1, wherein the protective cap comprises a plane surface at its upper part (1a), the housing accommodating the electronic display screen being formed in said plane surface.

7. The assembly of claim 6, wherein the plane surface forms a face that is oblique with respect to the axis (AA) of the cap, the axis (BB) of the screen and the axis (AA) of the cap forming between them an angle (α) less than less than 60°.

8. The assembly of claim 3, wherein the cap further comprises:
an electric power source configured to supply at least the electronic display screen with electrical current and
at least one internal housing in which the data processing system and the electric power source are arranged.

9. The assembly of claim 1, wherein the electronic display screen is selected from a liquid-crystal display screen, an electronic ink screen, an OLED display or a laser display.

10. The assembly of claim 1, wherein the carry handle is arranged on the cap in such a way that the electronic display screen is positioned between the carry handle and the valve-assembly.

11. The assembly of claim 3, wherein the electronic display screen displays at least one item of information chosen from the time, the date, a flow rate of gas delivered by the valve-assembly, a gas pressure inside the cylinder, an autonomy of the cylinder, an autonomy of the electric power source, an ambient temperature, an alarm, a name of a care establishment, an expiry date of a gas or an identity of the gas.

12. The assembly of claim 1, wherein the protective cap comprises an opening formed laterally in the protective cap and within which is housed a control member for controlling a gas flow rate.

13. The assembly of claim 1, wherein the protective cap comprises an opening formed laterally in the protective cap and within which is housed a control member chosen from a rotary handwheel configure to control a gas flow rate, a linear slider or a pivoting lever.

14. The assembly of claim 1, wherein a gas outlet connector allowing a gas delivered by the valve-assembly to be withdrawn is arranged in or projects in an opening formed laterally in the protective cap.

15. The assembly of claim 13, wherein the rotary handwheel is arranged coaxial with and able to rotate about a gas outlet connector within the opening formed laterally in the protective cap.

16. The assembly of claim 1, wherein the attachment device comprises two parallel arms able to pivot with respect to the body of the cap and forming securing hooks.

17. The assembly of claim 16, wherein the two parallel arms of the attachment device are configured and sized so as to allow the assembly to be secured or hooked onto a support of tubular shape, particularly a bar of a hospital bed or of a stretcher.
